(19) United States
(12) Patent Application Publication
(10) Pub. No.: US 2005/0261913 A1
(43) Pub. Date: Nov. 24, 2005

(54) Providing means to accrue miles or points

(76) Inventor: Patrick LaPointe, Princeton, NJ (US)

Correspondence Address: SYNNESTVEDT LECHNER & WOODBRIDGE LLP, P O BOX 592, PRINCETON, NJ, 08542-0592, US

(21) Appl. No.: 10/536,210

(22) PCT Filed: Nov. 21, 2003
(86) PCT No.: PCT/US03/37382

§ 371 Date: May 23, 2005

Related U.S. Application Data
(60) Provisional application No. 60/429,891, filed on Nov. 27, 2002.

(51) Int. Cl. G06F 17/60

(52) U.S. Cl. 705/1

(57) ABSTRACT

A method for allowing consumers to accumulate points, miles or other promotional currency (106) by acquiring an instrument (1A) (1B) capable of storing a certain amount of the promotional currency (106) and an additional amount of promotional currency or some other offers (112). The additional amount of the promotional currency or other offers (112) is stored on the instrument (1A) (1B) and hidden therein by some cloaking means (111), wherein the additional promotional currency (112) may be provided to the customer during a redemption.

### CROSS REFERENCE TO RELATED APPLICATIONS

This application claims the priority of provisional U.S. application Ser. No. 60/429,891, filed on Nov. 27, 2002 and entitled Method and System for Providing a Consumer With a Means to Accrue Miles or Points” by Patrick L. LaPointe, the entire contents and substance of which are hereby incorporated in total by reference.

### FIELD OF THE INVENTION

The present invention relates to methods and system for providing a consumer with a means to accrue miles, points, or other types of promotional currencies such as those commonly awarded by airlines, hotels, retailers, credit card issuers, and other companies.

### BACKGROUND OF THE INVENTION

Consumer research has indicated that more than 70% of households collect points, miles, or other promotional currencies (henceforth collectively, “promotional currencies”) issued by airlines, hotels, credit card issuers, retailers, and other businesses (henceforth “issuers”) in exchange for their patronage. As used herein, the term “issuers” shall not only include such entities as listed above, but third party designees of such entities as well. Normally, these promotional currencies are awarded in proportion to either the economic value of a purchase, the frequency of purchase behavior, or purchase behavior sustained over a period of time.

Consumers collect these promotional currencies in accounts held by the currency issuers in electronic formats until they have accrued sufficient amounts to redeem the currencies for one or more awards such as free or discounted air travel, free or discounted hotel rooms, free or discounted merchandise, or other free or discounted goods or services (henceforth “awards”). When an award is selected by the consumer, the promo currency is deducted from their account by the issuer in an amount and according to the prescribed process detailed in the rules of the “program” set by the issuer.

To redeem an award, or to verify the amount of promo currency in their account, consumers can contact the issuer by telephone, or use a computer to log onto the Internet website for the program maintained by the issuer or a third-party designee of the issuer. These means of accessing an account are often protected by password and/or PIN (personal identification number) such that only the consumer authorized to view or access the account may do so.

In many such programs issuing promotional currencies, the issuer allows the consumer to purchase additional promotional currencies directly from the issuer. By way of example, a consumer may wish to “top-off” his account should he require additional promo currency to redeem for a desired award. To do so, the consumer contacts the issuer either by telephone or website as described above, requests the necessary amount of promo currency to be added to their account, and then offers a form of payment (such as a credit card, debit card, or checking account draft number) to pay the issuer for the promo currency “top-off”. The issuer then adds the purchased promo currency into the consumer's account either immediately via electronic computer connection, or in a computerized batch process at some later point based upon a prescribed schedule.

Once the “top-off” promo currency has been added to their account, the consumer can redeem for the desired award(s) as described above.

The sale of promotional currencies by issuers to consumers has become a feature offered in many, if not most, of the larger programs incorporating such promotional currencies. It is estimated by those familiar with such programs that millions of consumers worldwide spend hundreds of millions of $US annually purchasing promo currency for “top offs” or other uses. Further, the practice of issuers selling promo currency to third parties for re-issuance has also evolved into a business unto itself with experts in the industry estimating that airlines alone sell tens of billions of promo currency units annually to “re-issuers” such as hotels, car rental companies, banks, insurance companies, and others. These re-issuers purchase the promo currency from the original issuer for an agreed price per unit, and then offer the purchased promo currency to their own consumers in exchange for patronage activity as previously described.

Issuers also sell promo currency units directly to re-issuers of all types for use as incentive awards. In such cases, a re-issuing company may purchase promo currency certificates (in paper or digital form) from the original issuer in various denominations, and then give the certificates to their customers or employees in recognition for positive behavior of some sort. When a consumer receives such a certificate, he can either mail it to the issuer for credit into his account or contact the issuer by phone or Internet website to record their certificate number and have the appropriate amount of promo currency added to their account.

As is well known to those skilled in the art, there are techniques in commercial printing which make it possible to print multiple graphic images onto paper, plastic, or other receiving media using offset, thermal, or ink-jet application of ink—and then cover one or more of those images with a substance that hides or “cloaks” the image from visual detection until the substance is removed. Such technology is often known in consumer parlance as “scratch-off” technology in which the consumer uses an item with a hard edge such as a coin or fingernail to remove the “cloaking” substance and expose the image.

These “scratch-off cards” have been used by marketers in a variety of promotional manners such as sweepstakes or other games of chance in which the consumer is asked to remove the cloaking substance from one or more image to determine what if any value the card itself then has as a proxy for cash or other prizes according to the rules of redemption set by the marketer. Similar “scratch-off cards” are also issued by regulated lottery operators as an instrument to participate in the lottery. Such cards are often found for sale in retail establishments of all types. They are also sold in bulk quantities to companies or consumers to be given away to customers, friends, relatives, or others for patronage or for personal reasons. Such cards are thus frequently given to consumers free of charge by businesses.

Those skilled in the art also know that modem computer technology has made it possible to duplicate the features and properties of these “scratch-off cards” in digital electronic format. In such cases, the consumer either goes to the website of a particular marketer and clicks on the appropriate “line”; or the consumer receives an e-mail which may direct them to the marketers web site or may have an attachment which, when opened, presents the consumer with the opportunity to identify one or more graphic buttons which can be “pushed” by click of a mouse to reveal what (if any) prize or value has been won. If the proper button(s) is/are selected, the value is revealed to the consumer. If an inappropriate button(s) is/are selected, the consumer is presented with nothing of value.

In such digital electronic formats, when the consumer clicks on an image which entitles them to an award of value, the marketer either credits the value into an existing account the consumer may hold with the marketer; or the marketer may require that the consumer perform one of more additional steps (such as providing information on themselves, opening an account, etc.) in order to realize the value in the digital certificate.

### SUMMARY OF THE INVENTION

The present invention provides a system and various methods by which the consumer can add promo currency to their account by acquiring an instrument which entitles them to add promo currency immediately into their accounts with issuers.

Additional advantages and novel features of the invention will be set forth in the description that follows and, in part, will become apparent to those skilled in the art upon examining or practicing the invention. The advantages of the invention may be realized and obtained by means of the instrumentalities and combinations particularly pointed out in the appended claims. To achieve these and in accordance with of the present invention, a system and methods are provided for providing consumers with means of acquiring “top-off” promo currency by purchasing or otherwise acquiring an instrument which entitles them to a prescribed amount of promo currency plus other valuable awards, all of which are immediately available for use through a telephonic and/or an electronic validation and authorization process.

One embodiment of the present invention is a card made of paper, plastic, or other materials or combinations of materials on which an amount of promo currency is printed or otherwise encoded. The amount of promo currency on the card is protected from visual inspection by one of several cloaking means. When the cloaking is removed, the amount of promo currency is revealed. The consumer then contacts the issuer either by telephone, via computer Internet links, or other forms of communication to enter the amount of promo currency depicted on the card into their account. Alternatively, when the cloaking is removed, the consumer may be presented with value other than promo currency, possibly taking the form of merchandise, discount certificates, or other products or services.

A system for providing this method is also provided, wherein the system comprises a base medium of paper or “plastic”; ink; a cloaking substance; telephone connections via wireline or wireless network; a CPU; memory operatively associated with the CPU; a data store operatively associated with the CPU; the data store including consumer profile data, issuer offering data, and/or merchant offering data; and program instructions executable by the CPU for performing the method described above. As used herein the term “merchant” is intended to include any person or entity which provides services and/or products to consumers.

An alternate system for providing this method is also provided, wherein the award presented to the consumer is in electronic form rather than the above described base medium. This system comprises telephone connections via wireline or wireless network; a CPU; memory operatively associated with the CPU; a data store operatively associated with the CPU; the data store including consumer profile data, issuer offering data, and/or merchant offering data; and program instructions executable by the CPU for performing the method described above.

Still other aspects of the present invention will become apparent to those skilled in the art from the following descriptions of various embodiments of the invention. As will be realized, the invention is capable of other different and obvious aspects, all without departing from the invention. Accordingly, the drawings and descriptions are illustrative in nature and not restrictive.

### BRIEF DESCRIPTION OF THE DRAWINGS

The accompanying drawings, incorporated in and forming part of the specification, illustrate several aspects of the present invention and, together with their descriptions, serve to explain the principles of the invention. In the drawings:

FIGS. 1A and 1B are illustrations of one embodiment of the present invention—the “physical instrument” embodiment;

FIG. 2 is a schematic illustration of an embodiment of the present invention;

FIG. 3 is a more detailed schematic illustration of the embodiment of FIG. 2;

FIG. 4 depicts one embodiment of a processing system according to the present invention;

FIG. 5 is an alternative embodiment of the processing system according to the present invention;

FIG. 6 depicts a flow diagram of a method according to an embodiment of the present invention using the “physical instrument” in FIGS. 1A and 1B; and

FIG. 7 depicts a flow diagram of an alternate method according to an embodiment of the present invention substituting a “digital instrument” for a “physical instrument”.

### DETAILED DESCRIPTION

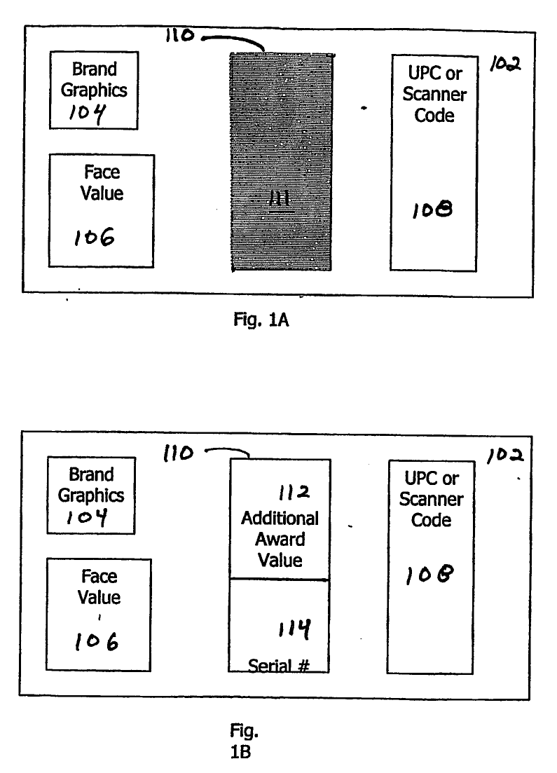

One embodiment of the present invention is depicted in FIGS. 1A and 1B. FIG. 1A illustrates an example of a card or other physical instrument 102 made of paper, plastic, or any other material onto which are imprinted several elements including: Brand Graphics 104; a Face Value amount 106 of promotional currency; a universal product code (UPC) or alternate product scanning code 108 making the card recognizable to electronic point-of-sale devices such as those commonly used to process transactions at retail locations; and an area 110 where the graphic image is initially obscured from visual detection by a “cloaking substance” 111 such as graphite, rubber, or other substance used for similar purposes. FIG. 1B depicts the instrument 102 after removal of the cloaking substance 111, exposing the graphic images comprised of the Additional Award Value 112 and a Unique Serial Number 114 on the card.

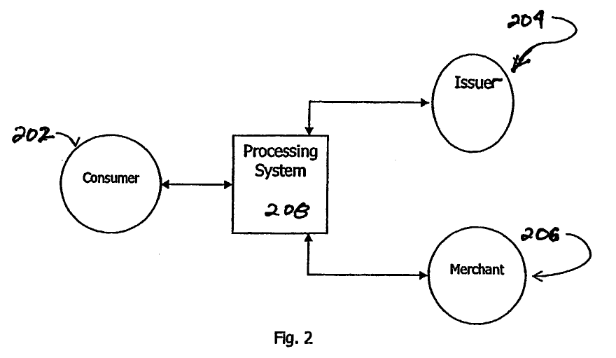

Another embodiment of the present invention is schematically illustrated in FIG. 2, wherein a consumer 202, an issuer 204, and a merchant 206 interact with a processing system 208 of the present invention. As used herein, the term “consumer” is intended to include any person or entity interested in obtaining an instrument and accumulating the promotional currency offered on the instrument for their own benefit, or re-issuing the promotional currency to other parties. The term “issuer” is intended to include any person or entity which offers promotional currency to other persons or entities in exchange for purchase or other economic behavior. The term “promotional currency” is intended to mean the unit of accounting (e.g., “points”, “miles”, “credits”, or other nomenclature as is well-known in the art) for the accrual of award value offered by issuers to consumers. The term “merchant” is intended to include any person or entity which provides services and/or products to consumers. It is understood that the term “merchant” includes the individual facilities of a single entity, such as the individual restaurants of a restaurant chain. The term “processing system” is intended to refer to any combination of manual or computerized steps taken by an entity authorized to accept data from consumers, issuers, and merchants (such an entity is henceforth referred to as a “processing company”) for the purpose of validating consumer awards and debiting or crediting the appropriate consumer accounts. In additional embodiments of the invention, the processing system acts as the central routing agent for profile and offer data.

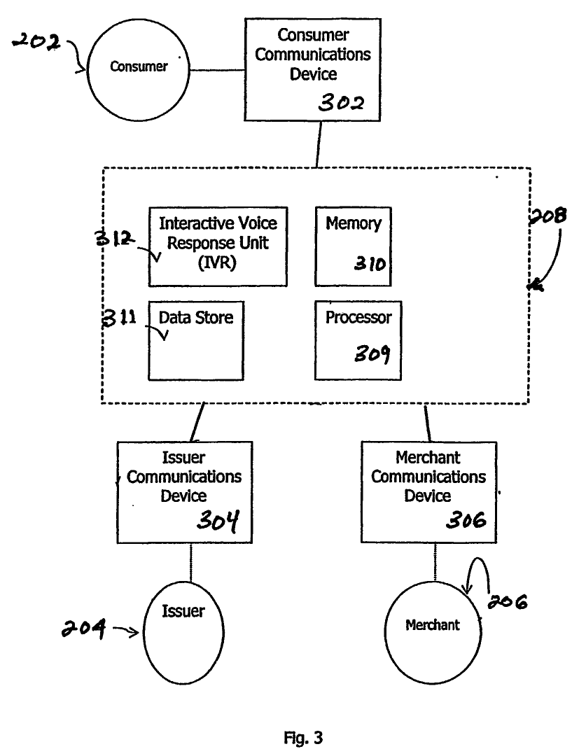

FIG. 3 is a more detailed schematic illustration of the embodiment of FIG. 2. As seen in FIG. 3, consumer 202 may interact with processing system 208 using a consumer communications device 302, while issuer 204 may interact with processing system 208 using an issuer communications device 304, and merchant 206 may interact with processing system 208 using a merchant communications device 306. It will be understood however that issuer 204 and merchant 206 may also provide issuer and merchant offer data respectively manually. For example, issuer 204 may provide issuer offer data in written form (e.g. mailing or faxing the information) to a service provider, such that the service provider will then enter the issuer offer data into processing system 208. Thus the methods and system of the present invention do not require that the issuer 204 have an issuer communications device 304, nor do they require that the merchant 206 have a merchant communications device 306 for interacting with the processing system 208. However, one embodiment of the present invention provides for dynamic interaction between consumer 202 and issuer 204 or merchant 206 through their respective communications devices 302, 304 and 306. Further embodiments allow the issuer and/or merchant to update their respective offer data at any time (e.g. on a daily or even more frequent basis).

It will also be understood that consumer 202, issuer 204, and merchant 206 may each use more than one communications device in order to interact with processing system 208. By way of example, consumer 202 may use both a stationary communications device (e.g. a desktop computer or a telephone communicating with processing system 208 using a wired connection via a modem or switch), as well as a mobile, wireless communications device (e.g. mobile telephone, personal digital assistant or “PDA”, a laptop computer, or other such device used for digital transmission of data over wireless spectrum). Consumer 202 may even provide potions of his or her consumer profile data manually, as described above for issuer 204 and merchant 206. In particular, consumer 202 may first establish an “account” with the processing company by accessing the processing system from a personal computer (e.g. desktop or notebook computer), such as through the Internet. The consumer will initially provide consumer profile data of a general nature (e.g. consumer name, address, frequent flyer account numbers, etc.). Thereafter, the consumer may use a wireless communications device to access the processing system of the present invention in order to transmit device serial numbers 114 and/or receive issuer or merchant offer data selected on the basis of the consumer profile data.

Processing system 208 may comprise a single computer or one or more computer systems (such as networked or distributed computer systems). As is well-known in the art, a computer generally includes any device capable of processing data in accordance with one of more instructions. Processing system 208 may therefore comprise any conventional or special purpose computer, such as a desktop computer, a notebook computer, a tower computer, a micro-computer, a mini-computer, a server, a web server, a workstation, a mainframe, or the like. In the embodiment depicted in FIG. 3, processing system 208 comprises a processor 309 (such as a CPU or a microprocessor), memory 310 (e.g. RAM, ROM, EPROM, or the like) operatively associated with processor 309, a data store 311 operatively associated with processor 309, and program instructions (not explicitly shown) executable by processor 309 for performing the methods of the present invention. It may also include an interactive voice response unit (henceforth “IVR”, also commonly known to those skilled in the art as a VRU) 312, which translates digital instructions received from telephones and program instructions received from processors into voice prompts for facilitating interaction between consumer and processing system when the consumer uses a wired or wireless telephone as their Consumer Communications Device 302.

As is well known to those skilled in the art, the program instructions may reside in various types of computer readable media including memory 310. A computer readable medium stores information readable by a computer, such as programs, data files, etc. As one with ordinary skill in the art will readily appreciate, a computer readable medium can take a variety of forms, including magnetic storage (such as hard drives, floppy diskettes, tape, etc.), optical storage (such as laser disks, compact disks, digital versatile disks (“DVD”), etc.), electronic stage storage (such as random access memory (“RAM”), read only memory (“ROM”), programmable read only memory (“PROM”), erasable programmable read only memory (“EPROM”), flash memory, memory sticks, etc.), and the like. Certain types of computer readable media, which are sometimes described as being non-volatile, can retain data in the absence of power so that the information is available when power is restored. The computer readable instructions of the present invention may be provided in any of a variety of programming languages known in the art hereafter developed (e.g., C, C++, Java, XML, etc.).

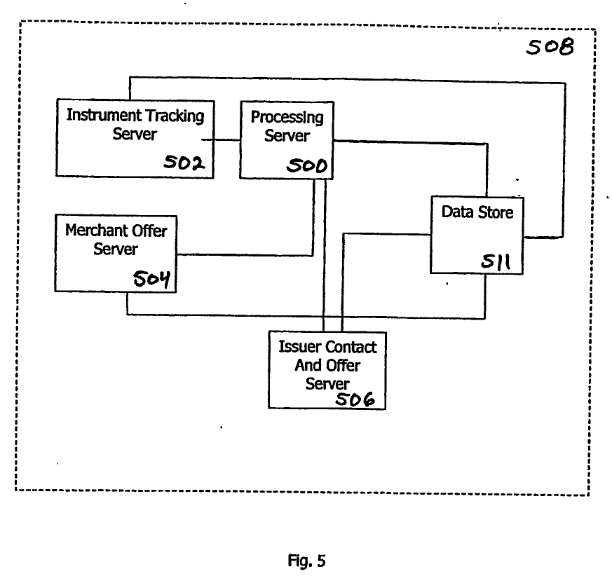

By way of example, processor 309 may be any of the commonly used processors made by Intel Corporation of Santa Clara, Calif. or one of Intel's competitors. However, it should be understood that the present invention is not limited to any one make of processor and the invention may be practiced using some other type of a processor such as a co-processor or an auxiliary processor. In addition, it will be understood that the multiple processors 309, memories 310, and data stores 311 may be employed, such as a networked or distributed computer system. For example, processing system 208 may comprise multiple computers (e.g. servers, particularly web servers) which are operatively associated with one another. In this manner, and as further described below in conjunction with FIG. 5, one server may compare customer profile data to the issuer contact and offer data, while another server is dedicated to validating the instrument serial number and a third is comparing customer profile data to the merchant offer data.

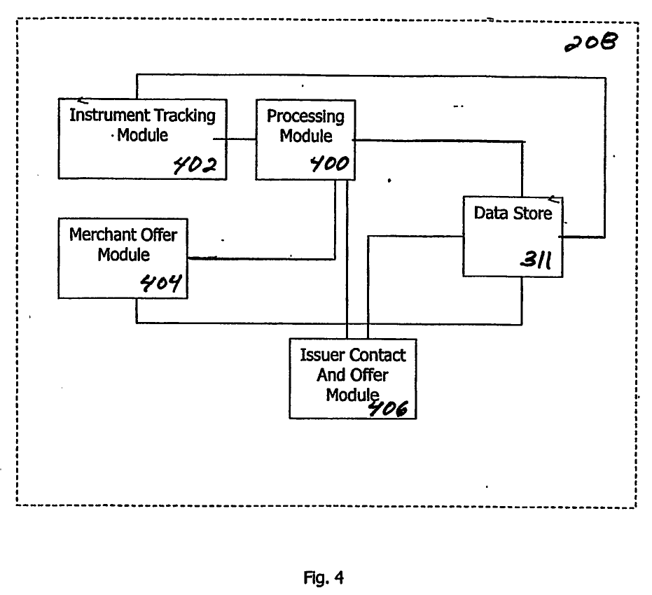

FIG. 4 is a further schematic illustration of the processing system 208 according to a further embodiment of the present invention, wherein a processing module 400, and an instrument tracking module 402 are depicted. These modules, for example, may each comprise a set of executable program instructions, such as in the form of software, routines, programs, algorithms, code and the like. As further described herein, the program instructions comprising these modules cause processing system 208 to carry out the methods of the present invention. For example, processing module 400 may compare consumer profile data to merchant contact and offer data while instrument tracking module 402 validates the serial number 114 of the instrument 102 being presented. Processing module 400 is preferably provided in communication with data store 311, consumer communications device 302, and merchant communications device 306 by any of a variety of well-known means. For example, consumer communications device 302 and merchant communications device 306 may communicate with processing module 400 via a software interface and a suitable communications link (e.g. a wired or wireless modem connection). Instrument tracking module 402, as well as merchant offer module 404 and issuer contact and offer module 406 may also be in communication with data store 311. Alternatively, separate data stores may be provided for each module.

Consumer communications device 302 may also communicate directly with instrument tracking module 402 such that data indicative of an instrument serial number 114 may be received and processed by instrument tracking module 402, and compared to valid instrument numbers stored, for example, in data store 311. This comparison of instrument data may be performed by instrument tracking module 402 and the results provided to processing module 400. Alternatively, instrument tracking module 402 may merely process the instrument data received from consumer communications device 302 in order to validate the format of the instrument serial number and then communicate the actual instrument serial number 114 to processing module 400 for comparison to the valid instrument numbers stored in data store 311.

As mentioned previously, the processing system of the present invention may also comprise multiple servers particularly, web servers) for carrying out the methods of the present invention. In many instances, this may improve the performance of the processing system, since each server is dedicated to one or more discrete tasks. In the embodiment shown schematically in FIG. 5, a processing system 508 includes a processing server 500, an instrument tracking server 502, a merchant offer server 504, an issuer contact and offer server 506, and one or more data stores 511 in operative communication with the servers. Each server may have its own data store or one or more common data stores may be employed. In the embodiment illustrated in FIG. 5, a single common data store 511 is employed, although the invention is not so limited. It should also be understood that each server may comprise one or more individual computers operatively linked to one another, wherein each computer includes at least a processor, memory operatively associated with the processor, and program instructions for performing the methods of the present invention. In the embodiment shown, the four servers (500, 502, 504 and 506) are operatively linked to one another, thus providing a computer network for performing the methods of the present invention in a more efficient manner.

It will also be understood that the various components of processing system 208 or 508 may be physically remote from one another, but in operative communication with each other (e.g. through the Internet). In addition, in the case of processing system 508, data store 511 may even comprise one of the servers (e.g. processing server 500).

The methods of the present invention generally provide merchant and issuer “offers” (for example, product or service descriptions, discounts, price quotations, directions to merchant or issuer locations, inventory information, contact information, promotional data, and the like) to a consumer based not only upon the instrument serial number 114 being presented, but also based on consumer profile data which is used to select merchant and issuer offers of potential interest to that particular consumer. In general, consumer 202 will initially establish contact with processing system 208, such as by establishing a personal account. This contact may be via a software interface such as a web client, or browser, particularly when processing system 208 comprises one or more web servers. As one skilled in the art will appreciate, however, any electronic interface may be used such as an IVR, or customized software designed to provide graphical user interface (GUI) screens and the like.

Once contact is established, the consumer 202 may provide (e.g. electronically submit) consumer profile data to processing system 208 which will receive and store consumer profile data in data store 311. Consumer profile data may include both public and private data, and the categorization of public and private data may even be a decision which the consumer 202 makes. Public consumer profile data may include, for example, the following information about the consumer: e-mail address, post office address, name, phone number, gender, age, travel preferences, desired services, desired products, expected prices to pay for products and services, and the like. Private data may include, for example, the consumer's social security number, credit card numbers, account passwords, income level, and the like. Public and private data are modifiable by the consumer 202 as desired. The processing system 208 may store both public and private consumer profile data in data store 311. In general, however, public consumer profile data will be made available to merchants 206 and issuers 204, while private consumer profile data will not.

After the consumer 202 has established an account and submitted at least general consumer profile data, the processing system 208 will use the consumer profile data to identify and select merchant and issuer offers of potential interest to the consumer 202. The selected merchant and issuer offer data will then be transmitted to the consumer and displayed on the consumer communications device 302. Moreover the consumer 202, issuer 204, and merchant 206 may be linked electronically through processing system 208 such that an electronic dialogue is established, and this dialogue will permit personalized exchanges (e.g. negotiations) between the consumer 202 and the issuer 204 or merchant 206.

The following hypothetical example depicts various features and capabilities of the invention. Joe (consumer 202) stops at Tony's Newsstand at Elmsville International Airport and purchases an instrument 102 with a face value of 50 frequent flyer miles. When Joe removes the cloaking substance 11 from the Instrument, he sees he has won 10,000 frequent flyer miles on his choice of New Jersey Airlines, Philly Air, or First Global Airlines, as well as the unique serial number 114 of the instrument. Joe, having previously established a profile (by accessing processing system 208 via a communications device such as desktop computer, a conventional wired telephone, a cellular phone, a personal digital assistant or “PDA”, a laptop computer, or an automobile computer or even manually by filling out a paper application and forwarding it to the processing company for entry into processing system 208) already has listed “accounts” which Joe maintains with New Jersey Airlines and Philly Air, as well as preferences for products, services, and or other things of interest to Joe.

Regardless of whether or not Joe has previously established a profile, Joe establishes a connection with processing system 208 using a notebook computer connected to the Internet. This connection may be established, for example, by modem connecting to an Internet service provider, and thereafter accessing a web site having one or more consumer interface web pages stored at or linked to processing system 208. Joe will “log in” to the service by entering his unique customer account number and possibly a secure password or personal identification number (PIN). Once Joe's account number and/or password or PIN is validated by processing system 208, processing system 208 will prompt Joe to enter the unique serial number 114 of the instrument 102 in his possession. Processing system 208 then verifies that the unique serial number of the instrument is valid and has not previously been “redeemed”. If confirmed, processing system 208 then sends back a message to Joe via his communication device asking which of the three airlines Joe would like his 10,000 miles credited to. When Joe responds via his communications device that he wishes to have his miles credited to Philly Air, processing system 208 compares the consumer profile data with merchant offer ata and issuer (in this case, Philly Air) offer data stored in data store 311. If processing system 208 identifies a match between merchant offer data and/or Philly Air offer data, it sends back a message to Joe via his communications device which includes: confirmation of the 10,000 frequent flyer miles having been entered into his account with Philly Air; an offer from Philly Air to double the award to a total of 20,000 miles if Joe books another flight on Philly Air within the next 30 days; and an offer from Busy Car Rental (the merchant selected by processing system 208 as having the most preferential offer for Joe) for a free upgrade to a larger car on Joe's next booking.

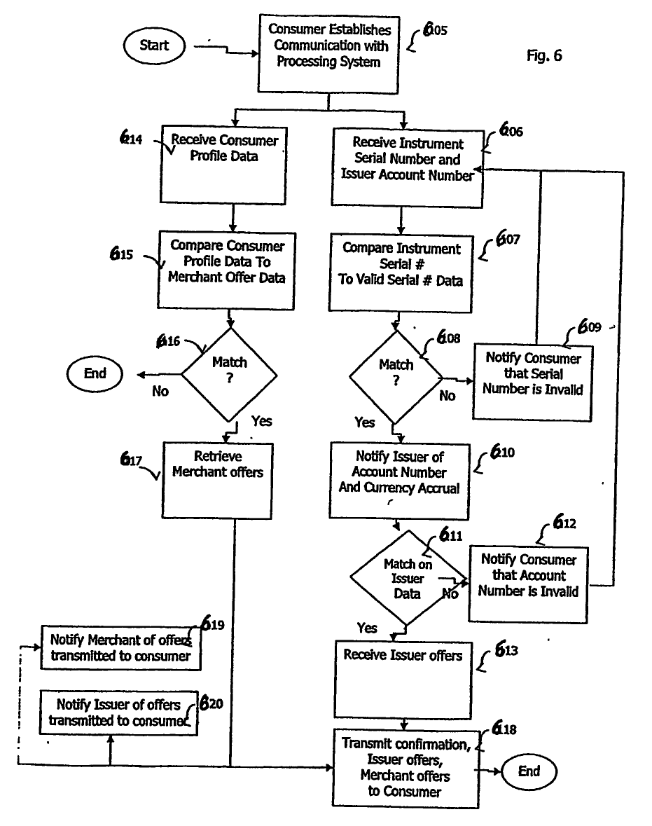

FIG. 6 illustrates a flow diagram of one embodiment (similar to the above hypothetical example) of a method for recording with an issuer 204 the number of miles from a given in ent into the account of a consumer 202 and providing selected merchant 206 and issuer 204 offer data to the consumer. The embodiment shown in FIG. 3 permits a merchant or issuer to electronically provide offer data to a consumer. The flow diagram of FIG. 6 assumes that one or more merchants have previously established electronic communications to processing system 208 (e.g. via a merchant communications device 306), and that processing system has received from the merchant (and stored in data store 311) merchant offer data. The flow diagram illustrated in FIG. 6 also assumes that one or more issuers have previously established electronic communications to processing system 208 (e.g. via an issuer communications device 304), and that processing system has received from the issuer (and stored in data store 311) consumer account numbers held with the issuer and issuer offer data. As used herein, merchants include non-profit organizations, for-profit organizations, government organizations, private organizations, and the like. Moreover, without intending to limit the scope of the present invention, merchants can include retail stores, restaurants, service shops (e.g., as automotive repair shops), and the like. In other words, a merchant can be any entity desiring to provide merchant offers to a consumer.

Once the merchant 206 has subscribed to the system (e.g. established an account with the processing company), the merchant establishes communications with the processing system. By way of example, the merchant may establish communication using a personal computer or any other computing device. Once the merchant has logged into the system, the merchant may submit general merchant offer data which includes, for example, the geographic location(s) of the merchant, contact information, general product or service information (e.g. retailer specializing in golf equipment), email address(es), web links, and the like. Moreover, the merchant may submit specific merchant offer data including more specific product information (for example, if the merchant were a restaurant, product information would include menu selections like sushi, lobster, tuna, etc.), current price quotes, available specials or discounts (e.g. senior citizen discount), advertisements, inventory data, promotional data, special event information, and the like. The merchant offer data (both general and specific) are received by the processing system and stored in data store 311.

The merchant may at any time modify, delete, or add merchant offer data as needed by accessing processing system 208 in the same manner. For example, the merchant may update its inventory, pricing, and current specials on a daily (or more frequent) basis, as desired. For example, each morning, a seafood restaurant may submit additional vendor offer data indicating its current inventory (e.g. the types of sushi currently available) and daily price specials.

In the case of a retail merchant, the merchant may submit merchant offer data reflecting a current special (e.g., a sale on an overstocked item) available only for a short period of time (e.g. a few days or less). Often in such instances, the retail merchant has no other effective means of alerting consumers of the special offer due to the short duration of the offer. The processing system of the present invention will allow the merchant to broadcast the special offer to consumers potentially interested in the item (based on their consumer profile data). For example, a consumer may submit consumer profile data indicating their interest in golf. If a merchant has a special offer on an overstocked golf club, the processing system will identify a “match” between the consumer profile data (i.e., the consumer is a golfer) and the merchant offer data (i.e., the special offer on the overstocked golf club). In this manner, the special offer will be broadcast to the consumer in question if the consumer has indicated in their profile an interest in receiving merchant offers related to golf specifically, or to sporting goods more generally, or even to “special sale items” yet more generally.

FIG. 6 is a flow diagram illustrating various functions that are performed by the system when a consumer attempts to “redeem” an instrument 102. This flow diagram assumes that the consumer has previously registered with the service provider, although this is not required. By previously accessing (“logging into”) the processing system of the present invention, the consumer will have submitted at least general consumer profile data which is then stored in data store 311. When the consumer 202 first accesses the processing system, he/she will typically transmit to processing system 208 general consumer profile data such as email address, post office address, name, phone number, age, sex, social security number, credit card numbers, account passwords, income level, clothing sizes, color preferences, desired services, interest, hobbies, desired products, expected prices to pay for certain services and products, and the like. It will be understood that this general consumer profile data may be entered from a stationary communications device (e.g., a home desktop computer or conventional wired telephone) via a wired connection, or, via a PDA, mobile telephone, notebook computer, or other similar wireless device. This general consumer profile data will be stored by processing system 208 in data store 311. The consumer may modify the general consumer profile data at any time, as desired. In addition, the consumer may also enter specific consumer profile data (also referred to as “consumer request data”) by logging into the processing system of the present invention. This specific consumer profile data (i.e., request data) may include, for example, specific products or services the consumer is interested in at that time (e.g. sushi at 3 am).

Referring now to FIG. 6 in detail, the consumer will connect to the processing system (step 605) with a wired or wireless communication device such as a personal computer, a hand-held computing device (e.g., a PDA), a digital phone, or automotive computer, although any communication device will suffice. As discussed previously, however, by way of example, the consumer may directly connect to the system with a wireless communications device and interface with the system through a web browser, accessing web pages designed to provide a software interface which permits bi-directional communications between the consumer and the processing system. Although as one skilled in the art will appreciate, other suitable software interface programs may be used. Alternatively, the consumer may connect to the Internet (such as by using an existing Internet access account) and then log into the processing system of the present invention (e.g. through the World Wide Web using a conventional web browser as an interface).

Once communication has been established, the consumer may submit the instrument serial number(s) 114 and issuer account information. The processing system 208 receives this information in step 606, as well as consumer profile data, in step 614. Next, while the processing system 208 compares the instrument serial number(s) entered by the consumer against the valid serial numbers stored in data store 311 (step 607), the consumer profile data is compared to merchant offer data stored in data store 311 (step 615). If (at step 608) the instrument serial number(s) submitted by the consumer do not “match” with the database of valid instrument serial numbers held in the data store (e.g., instrument serial numbers coded as “issued unredeemed”), the processing system will send a notification to the consumer (step 609) through the consumer communications device 302. This notification would typically explain the nature of the mis-match (e.g. “invalid instrument serial number” for entered numbers not present in data store 311 or stored and coded with status of “non-issued” or “previously redeemed”) and ask the consumer to re-enter the instrument serial number(s). This process will be repeated until a “match” is found, the consumer terminates communication with the processing system, or the processing system refuses to accept another attempt for that same serial number.

If the instrument serial number(s) entered by the consumer correspond with valid numbers in data store 311, the processing system will retrieve from data store 311 the consumer's account number(s) and any necessary passwords or personal identification numbers (PINS) designated by the consumer (for that issuer account) to receive the currency award depicted on the instrument. The processing system 208 will then send notification to the issuer (step 610) via the issuer communications device 304 that the consumer account number(s) presented should be credited with the indicated amount of currency, and await confirmation from the issuer that the account number is a “match” with data stored at the issuer and that the transaction is accepted (step 611).

If the issuer cannot confirm the “match”, the consumer is notified that the account number is invalid (step 612) and asked to update their profile data with correct account numbers and/or contact the issuer to resolve the mismatch. This process will be repeated until either a “match” is found or the consumer terminates communication with the processing system. In the event that the communication between the consumer and the processing system is terminated without the determination of a “match” to issuer account number, the status of the instrument 102 with that serial number 114 will be changed to “pending”.

Once the issuer confirms the “match”, the processing system sets the status of the instrument serial number to “redeemed” and retrieves from data store 311 any issuer offer data (step 613) which corresponds to the consumer profile, the instrument serial number presented, or any other data indicating that the consumer may be receptive to the issuer offer.

As further depicted in FIG. 6, while the above steps are being performed, the processing system also is performing the “match” function on the consumer profile data against the merchant offer data stored in data store 311 (step 615). If (at step 616) there is a “match”, the processing system retrieves the corresponding merchant offer data (step 617) from data store 311. The processing system 208 will then notify the consumer 202 via the consumer communications device 302 that their selected issuer account has been credited with the amount of currency indicated on the instrument, and simultaneously present one or more merchant offers and/or issuer offers identified in the “matching” processes (step 618). Finally, the processing system notifies the merchant (step 619), the issuer (step 620), or both that their offers have been delivered to the consumer.

Processing a “match” at step 611 between consumer profile data in data store 311 and issuer offer data in data store 311 is a function of establishing substantial correspondence between the consumer profile data entered by the consumer and the issuer offer data which has been identified as being of relevant interest to a consumer whose profile includes certain specific elements deemed to be predictive of said interest. In this manner, the processing system of the present invention will essentially select which portions of the issuer offer data should be transmitted to the consumer based on the consumer's profile, history of instrument redemption activity, and/or present instrument redemption activity. Similarly, processing a “match” at step 616 between consumer profile data in data store 311 and merchant offer data in data store 311 is also a function of establishing substantial correspondence between the two.

“Substantial correspondence” between data can be determined in a variety of manners, which are readily apparent to those skilled in the art. For example, “substantial correspondence” between consumer profile and merchant offer data may be determined by processing module 400 (or processing server 500) in a variety of manners. For example, in one embodiment of the present invention, data store 311 comprises a relational database, which uses relational techniques for storing and retrieving data in an efficient manner. Both merchant offer data as well as consumer profile data may be stored in the relational database, and compared to one another in order to determine “substantial correspondence” (l.e., a “match” between portions of merchant offer data and consumer profile data. For example, consumer profile data may be used to formulate a database query designed to identify matching merchant offer data. A numerical value may be associated with each database record (the merchant offer data) contained in the answer set of the database query. A predetermined threshold value (e.g. 90 out of a possible 100) may be used to define which merchant offer data in the answer set is transmitted to the consumer. The threshold value may be configured by the user, or may vary depending upon the topic of interest.

As yet another alternative, since the interface used by the consumer and the merchant to enter profile data and offer data, respectively, is defined via predetermined web interface pages, categories of interest can be electronically normalized eliminating errors associated wit the multiple permutations used by individuals to identify the same concept. Moreover, items stored in the database records for searching may be stemmed, so that morphological roots associated with words do not prevent valid search hits during a database query.

Additionally, hierarchies of interest may be provided via the web page(s) for selection by the consumer. This would provide for a controlled way in which vendor offer data is recorded and stored in the data store and the way in which consumers identify their consumer profile data. For example, a hierarchy four levels deep for the topic “clothes” might include clothes-dresses-red-size 9. By forcing a consumer to use this hierarchy as well as the merchant before entering variable information such as prices and inventory number, software can easily be constructed to find matches. Parameters may also be established by the merchant and/or consumer such that “substantial correspondence” does not require an exact match in each level of the hierarchy (e.g. merchant offer data concerning size 9 dresses in colors other than red is deemed a “match” due to substantial correspondence with the consumer profile data). Any of a variety of other well-known software-implemented techniques may be used for locating matches (i.e. substantial correspondence) between consumer profile data and vendor offer data, such as various algorithms or decision trees.

It is also contemplated that the consumer may designate which portions of his or her profile data should be used in performing the matching analysis. For example, the consumer may specify that only specific elements of the consumers profile data can be used, rather than the entire profile. As yet another alternative, the consumer may even request to receive all merchant offer data from all merchants in some or all categories, thereby overriding the requirement for substantial correspondence between consumer profile data and merchant offer data before the merchant offer data is transmitted to the consumer.

Similar well-known methods as those described above can be used to establish significant correspondence between issuer offer data and consumer profile data.

Use of consumer profile information is contemplated in a further embodiment of the invention in which the consumer's communications device 302 utilizes Internet access to the processing system. In particular, the consumer's web interface page, while connected to the processing system of the present invention, may also display advertisement data transmitted by the processing system. The advertisement data may vary according to the consumer profile data, the present instrument being redeemed, or the history of instrument redemption.

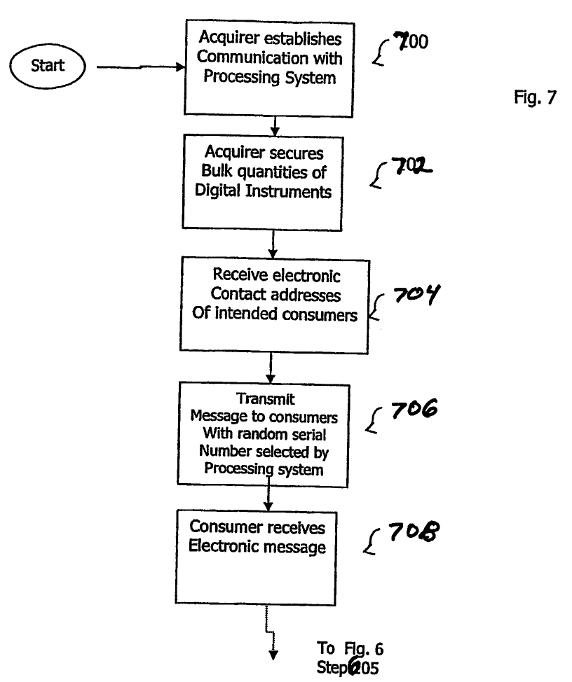

An additional embodiment of the invention relates to the means by which a consumer acquires the promo currency instrument. This is illustrated in FIG. 7 wherein an Acquirer (who may be an individual, an organization, a company, etc.) secures one or more instruments with an intention to distribute them to consumers. In this method, the Acquirer establishes communication with processing system 208 through a communications device (step 700) such as those described earlier. The Acquirer then secures the desired quantity of instruments from the processing company (or processing company's designee) in exchange for some consideration, financial or otherwise (step 702). Each of these instruments is in electronic form, and hereafter will be referred to as “digital instruments”. The Acquirer then provides names and contact information (e.g. email or postal address) for each of the consumers to whom they would like to send digital instruments, along with a specified number of instruments for each consumer (step 704). The processing system will then send email(s) or letters via postal service to the designated consumer(s) notifying them that the Acquirer has arranged for them to receive digital instrument(s) free-of-charge and providing the information necessary for how they can contact the processing company to receive these instruments (step 706). The consumer then receives this notification (step 708) and establishes communication with the processing system as described earlier (step 605) in order to receive their instrument(s). The process then commences as earlier described with respect to FIG. 6.

In another embodiment of the invention, an instrument could be obtained by the consumer by presenting a magnetic striped or chip-encoded card, or simply entering a unique identifying account number at an electronic self-service station (commonly known as a “kiosk” or “self service kiosk”) station located in an airport, hotel, retail establishment, or any other location of frequent consumer traffic. The kiosk would then communicate with the processing system 208 and/or the issuer communications device 304 and provide the consumer with a tangible or digital instrument. For example, in one execution of the present embodiment, the consumer may swipe a debit or credit card with a magnetic stripe at a kiosk in a supermarket and be presented with an opportunity to acquire one or more digital or tangible instruments immediately and have the cost of the instruments billed to their card account or other means of payment. In another execution, the consumer may enter their frequent flyer account number into a kiosk at an airport and be presented with one or more digital or tangible instruments without charge as a gesture of gratitude from the selected airline or one of the airline's partner merchants. The instrument may be accompanied by one or more promotional messages from the issuer and/or merchants presented electronically or in tangible form. The consumer may then have the opportunity to use the kiosk (or other consumer communications device 302) to enter into a dialogue with the provider of the promotional message.

In another embodiment of the invention, the kiosk could be a ‘slot machine’ (such as those commonly found in a casino) into which the consumer would swipe their magnetic striped or chip-encoded card or simply enter a unique identifying number, input a certain amount of money in the form of cash, credit, debit, or stored value card, and activate the machine. The slot machine would then act as the consumer communications device, connecting with one or more processing systems in real time or in batch process to update the consumer's account with the appropriate amount of currency, which would be determined by the same processes such machines use to determine the probabilities of certain outcomes in their present capacity. Note that in this embodiment, the consumer may or may not be guaranteed to receive an amount of currency proportionate to the amount of money they wager in the machine.

In another embodiment of the present invention, the instrument may be issued at the point-of-sale (“POS”) by a clerk at a retail establishment (where “retail establishment” is intended to include any place where a consumer would physically go to buy goods or services). In this embodiment, the consumer, upon presenting their items for purchase along with some form of identification (e.g., credit card used for payment, merchant loyalty card, customer phone number, etc), would receive from the clerk a tangible instrument generated by the POS computer device (such as those currently used by major retailers and restaurants throughout the world) which may take the form of a message printed upon the purchase receipt or a separate message provided independent of the receipt. The decision to issue any number of instruments (including 0) to the consumer at the POS could be dictated by information held by the retailer with regard to the specific consumer's profile, past or present behavior, payment type, or any other data stored upon the retailer's date store connected to the POS device. Once issued, the instrument would contain instructions for the consumer to call a certain telephone number or link electronically to a certain web site address and enter a certain instrument serial number to find out what their award value is. The process would then be repeated as described in earlier embodiments.

In yet another embodiment of the invention, the physical instrument containing the face value award (the certain amount of promo currency) may be a box, can, bottle, bag, or other form of packaging of a product. In such instances, the cloaking mechanism may be the visual impenetrability of the external package. Only when the package is opened (e.g. removing the bottle cap or tearing open the box top) are the additional award value and instrument serial number revealed. For example, the certain face value of promo currency may be printed or otherwise presented on the outside face of a can or soda or box of cereal, along with instructions to look inside the package for the potential of additional award value. The consumer would then remove the top of the can or box to reveal the additional award value and serial number printed underneath the top of the can/box or otherwise contained within the package or displayed elsewhere on the interior surface of the package.

In still another embodiment of the invention, the issuer may be a governmental or quasi-governmental organization operating a lottery or other game-of-chance under governmental permit and/or regulation (henceforth, “lottery”). In this embodiment, the lottery could acquire (for consideration of a financial or other nature) the exclusive or non-exclusive rights to distribute physical and/or digital instruments contemplated by the present invention within a defined geographic territory. The lottery could act as an Acquirer, or as a re-issuer for an established issuer, or become an “issuer” by creating its own brand of promo currency and establishing its value of that promo currency by setting redemption exchange amounts required for one or more specific awards (e.g. 1000 “XYZ lottery points” equals a free 27” television set). In such an embodiment, the lottery may or may not include the offers or messages from merchants or other third parties as part of the communication with consumers or Acquirers. At their option, the lottery may also award any authorized resellers with the same or similar promotional currencies for activities relating to the sale or distribution of instruments through physical or electronic channels under their control. The lottery may or may not elect to act as their own processing company in managing this processing system.

The above-described algorithms and steps contained therein can be implemented using standard well-known programming techniques. The novelty of the above-described embodiment lies not in the specific programming techniques but in the use of the steps described to achieve the described results. In a client/server environment, such software programming code may be stored with storage associated with a server. The software programming code may be embodied on any of a variety of known media for use with a data processing system, such as a diskette, or hard drive, or CD_ROM. The code may be distributed on such media, or may be distributed to users from the memory or storage of one computer system over a network of some type to other computer systems for use by users of such other systems. The techniques and methods for embodying software program code on physical media and/or distributing software code via networks are well known and will not be further discussed herein.

The foregoing descriptions of the present invention have been presented for purposes of illustration and description. They are not intended to be exhaustive nor to limit the invention to the precise forms disclosed. Many alternatives, modifications, and variations will be apparent to those skilled in the art in light of the above teaching. For example, although a web browser was used to describe the primary interface for a merchant and a consumer, any communication interface will suffice and would be readily apparent to one skilled in the art. Accordingly, this invention is intended to embrace all alternatives, modifications, and variations that fall within the spirit and broad scope of the attached claims.

1. A method for allowing a consumer to accumulate promotional currency; said method comprising the steps of:
acquiring by said consumer, an instrument, said instrument comprising a unique serial number, a face value amount of promotional currency and an additional award indicia wherein said serial number and said additional award indicia are both initially hidden by a cloaking means, thereby rendering them unreadable;
enabling said consumer to remove said cloaking means upon completion of said acquiring step; and,
redeeming by said consumer the amount of promotional currency and the additional award contained on said instrument.

2. The method of claim 1 wherein said redeeming step further comprises the steps of:
entering said serial number into a remote system;
validating the instrument's authenticity using said entered serial number; and,
recording in an account of said consumer the amount of promotional currency and the additional award.

3. The method of claim 2 wherein said instrument is selected from the group consisting of tangible instruments and digital instruments.

4. The method of claim 3 wherein said acquiring step comprises an obtaining means selected from the group of purchasing by the consumer, receiving as a gift, obtaining as an award, obtaining via electronic means, obtaining via postal service, obtaining from an issuer, obtaining from a third party agent of the issuer, obtaining from a marketer, obtaining from a merchant, obtaining from an Acquirer, and combinations thereof.

5. The method of claim 4 wherein the additional award has a value, said value having been assigned by the issuer in accordance with probabilities of payout.

6. The method of claim 5 wherein said redeeming step further comprises the steps of:
requiring the consumer to establish a customer profile as a prior condition for said recording step; and,
presenting to the consumer one or more offers from said issuer or said merchant based upon said customer profile.

7. The method of claim 6 wherein said redeeming step is performed using electronic transmission.

8. The method of claim 7 further comprising the step of communicating an advertisement to the consumer, the content of said advertisement at least partially determined based upon said customer profile.

9. The method of claim 6 further comprising the steps of:
updating said consumer profile with information obtained from said redeeming step; and,
augmenting said consumer profile with supplemental information obtained from additional sources.

10. The method of claim 9 wherein said augmenting step comprises the step of accessing one or more data bases to obtain a history of purchases by the consumer.

11. The method of claim 1 wherein said instrument was issued by an issuer and said redeeming step further comprises the steps of:
entering said serial number into a remote system;
validating the instrument's authenticity using said entered serial number; and,
communicating to the issuer an account number of the consumer and the amount of promotional currency and the additional award.

12. The method of claim 1 further comprising the step of:
providing said instrument in the packaging of a product purchased by the consumer.

13. The method of claim 1 further comprising the step of:
providing said instrument to the consumer via a point-of-sale device at a checkout lane in a retail establishment.

14. The method of claim 1 further comprising the step of:
providing said instrument to the consumer via a self-service kiosk.

15. The method of claim 1 further comprising the step of:
providing said instrument to the consumer via a government lottery operation.

16. A data storage medium comprising indicia of instructions for a processor to perform a method of allowing a consumer to accumulate promotional currency; said method comprising the steps of:
acquiring by said consumer, an instrument, said instrument comprising a unique serial number, a face value amount of promotional currency and an additional award indicia wherein said serial number and said additional award indicia are both initially hidden by a cloaking means, thereby rendering them unreadable;
enabling said consumer to remove said cloaking means upon completion of said acquiring step; and,
redeeming by said consumer the amount of promotional currency and the additional award contained on said instrument.

17. The method of claim 16 wherein said redeeming step further comprises the steps of:
entering said serial number into a remote system;
validating the instrument's authenticity using said entered serial number; and,
recording in an account of said consumer the amount of promotional currency and the additional award.

18. The method of claim 17 wherein said redeeming step further comprises the steps of:
requiring the consumer to establish a customer profile as a prior condition for said recording step; and,
presenting to the consumer one or more offers based upon said customer profile.

19. The method of claim 18 further comprising the step of communicating an advertisement to the consumer, the content of said advertisement at least partially determined based upon said customer profile.

20. The method of claim 18 further comprising the steps of:
updating said consumer profile with information obtained from said redeeming step; and,
augmenting said consumer profile with supplemental information obtained from additional sources.

21. The method of claim 16 wherein said instrument was issued by an issuer and said redeeming step further comprises the steps of:
entering said serial number into a remote system;
validating the instrument's authenticity using said entered serial number; and,
communicating to the issuer an account number of the consumer and the amount of promotional currency and the additional award.

22. An apparatus for crediting an account of a consumer with promotional currency; said apparatus comprising:
an instrument acquired by the consumer, said instrument comprising a unique serial number, a face value amount of promotional currency and an additional award indicia wherein said serial number and said additional award indicia are both initially hidden by a cloaking means, thereby rendering them unreadable;
means for enabling said consumer to remove said cloaking means; and,
means for redeeming by said consumer the amount of promotional currency and the additional award contained on said instrument.

23. The apparatus of claim 22 wherein said means for redeeming further comprises:
means for entering said serial number into a remote system;
means for validating the instrument's authenticity using said entered serial number; and,
means for recording in the account of said consumer the amount of promotional currency and the additional award.

24. The apparatus of claim 23 wherein said means for redeeming further comprises:
means for requiring the consumer to establish a customer profile; and,
means for presenting to the consumer one or more offers based upon said customer profile.

25. The apparatus of claim 24 further comprising:
means for updating said consumer profile with information obtained from the consumer; and,
means for augmenting said consumer profile with supplemental information obtained from additional sources.

26. The apparatus of claim 22 wherein said instrument was issued by an issuer and said means for redeeming further comprises:
means for entering said serial number into a remote system;
means for validating the instrument's authenticity using said entered serial number; and,
means for communicating to the issuer an account number of the consumer and the amount of promotional currency and the additional award.
